(19) United States
(12) Patent Application Publication
(10) Pub. No.: US 2003/0029937 A1
(43) Pub. Date: Feb. 13, 2003

(54) Emitter with water inlet filter and method of assembly thereof

(76) Inventors: Emmanuil Dermitzakis, Athens (GR); Aristides Dermitzakis, Athens (GR)

Correspondence Address: Emmanuil Dermitzakis, 16 - 18 Papada Street, Athens, GR-115 25, GR

(21) Appl. No.: 10/204,536

(22) PCT Filed: Feb. 28, 2001
(86) PCT No.: PCT/GR01/00012

(30) Foreign Application Priority Data
Feb. 28, 2000 (GR) 20000100065

(51) Int. Cl. B05B 15/00

(52) U.S. Cl. 239/542

(57) ABSTRACT

Emitter with water inlet hole which bears a circumferential ring and elastic membrane that covers it tightly. The water penetrates to the emitter from the ring only if particular water pressure to the network is reached which slightly raises the membrane forming a gap.

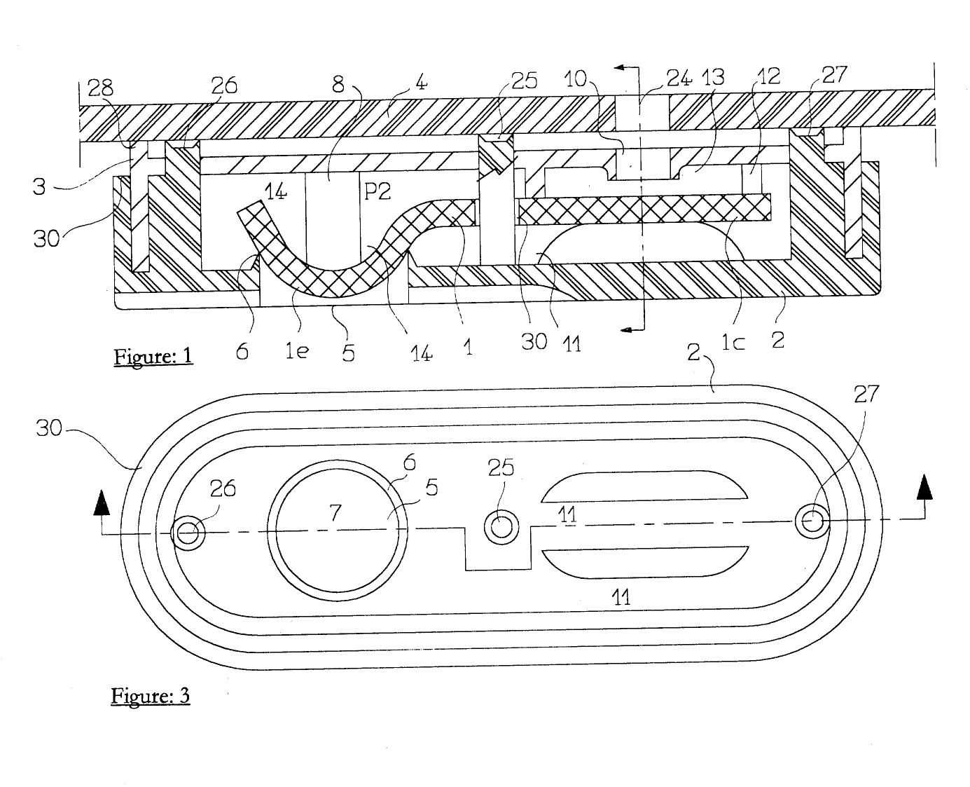

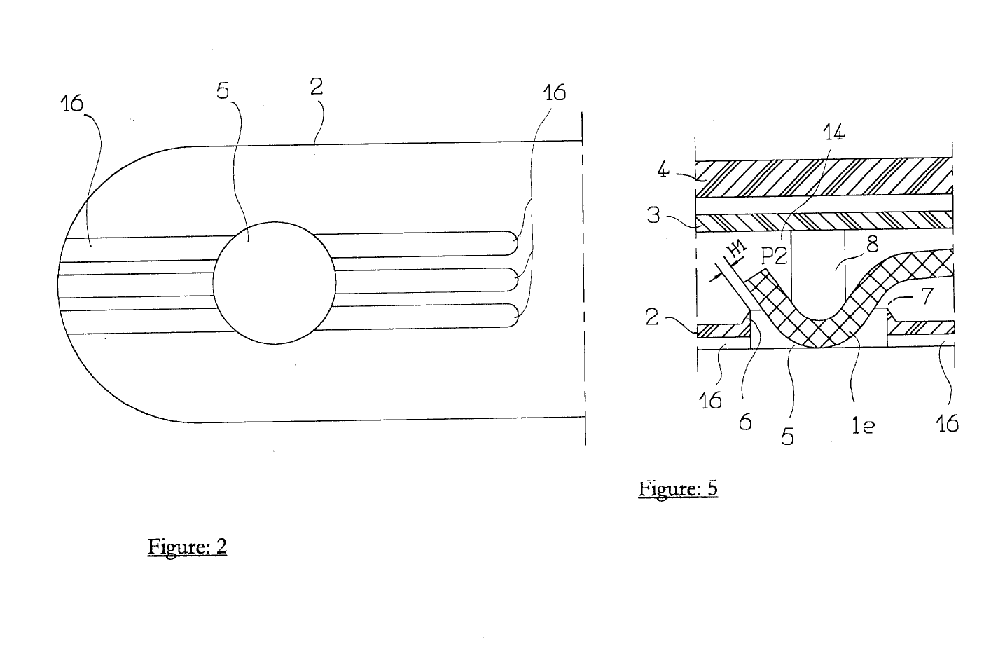

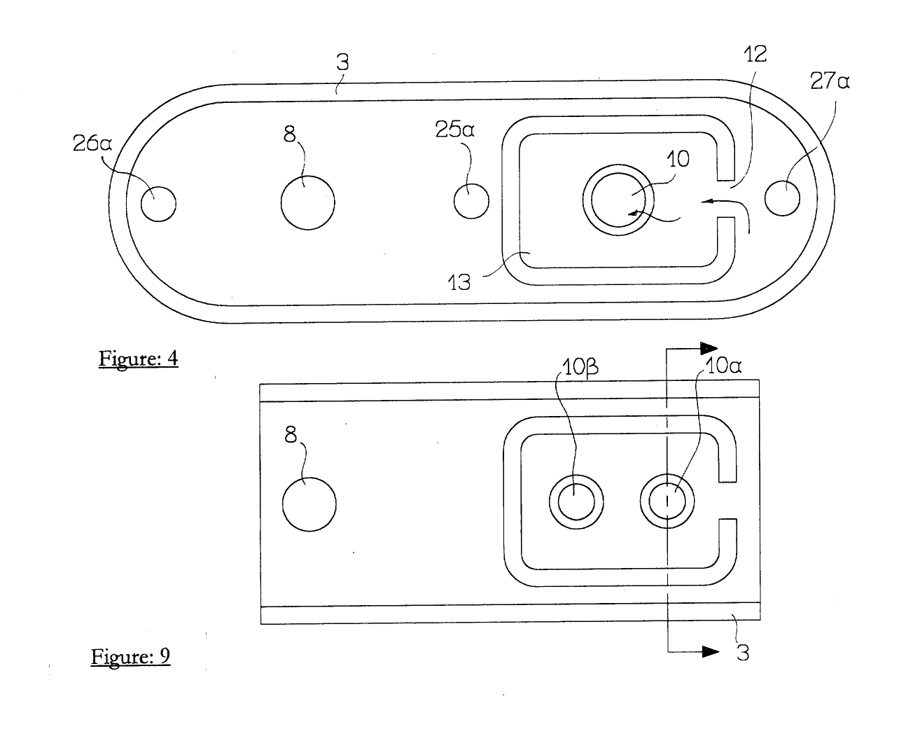

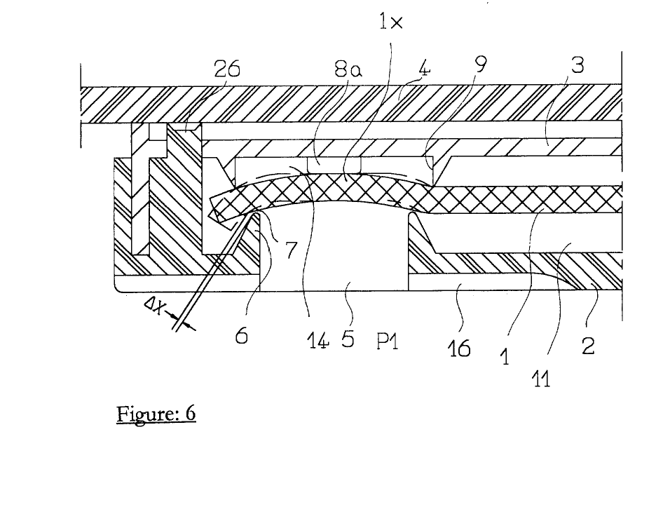

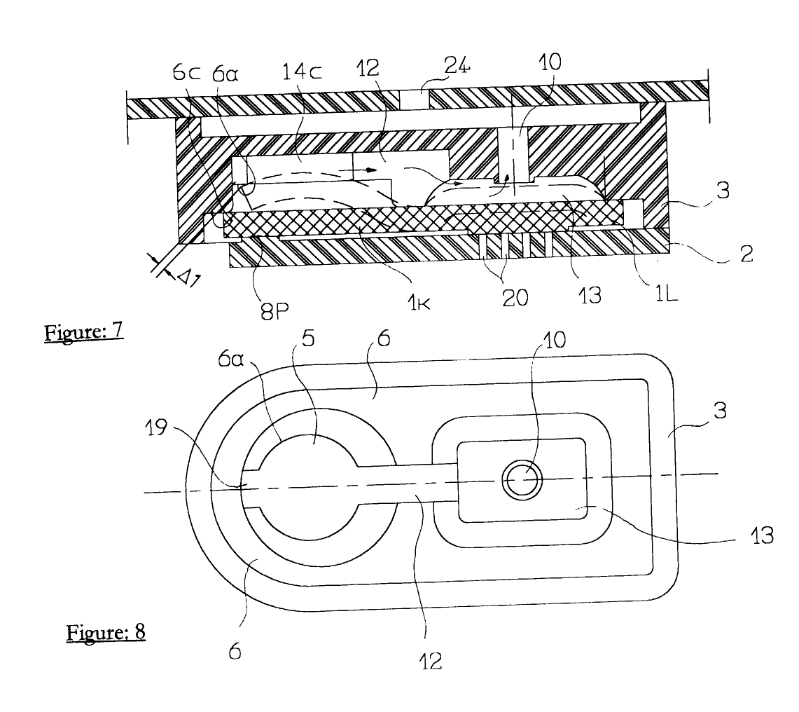

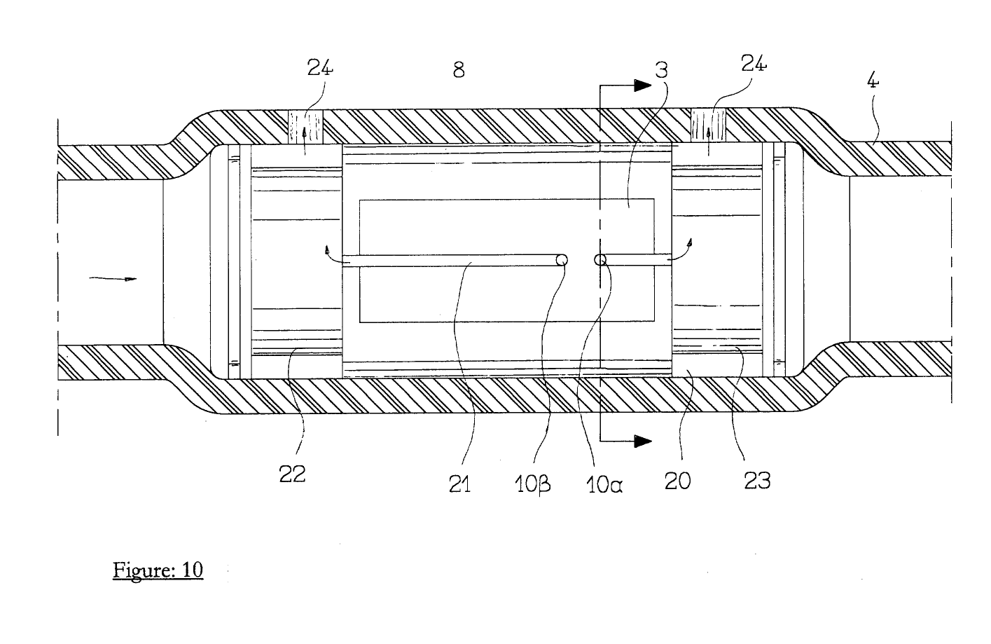

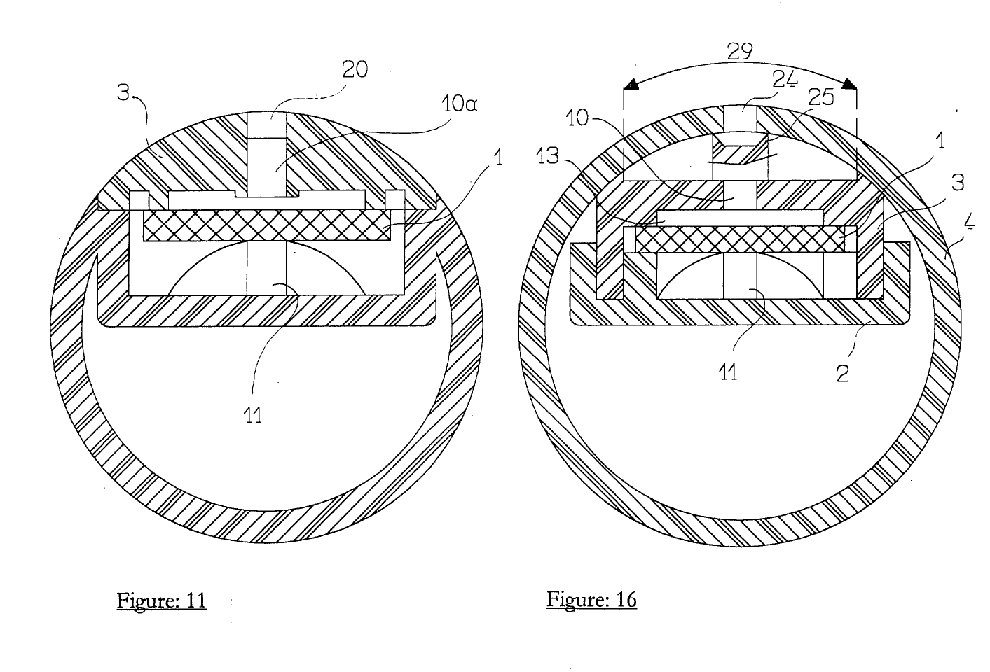

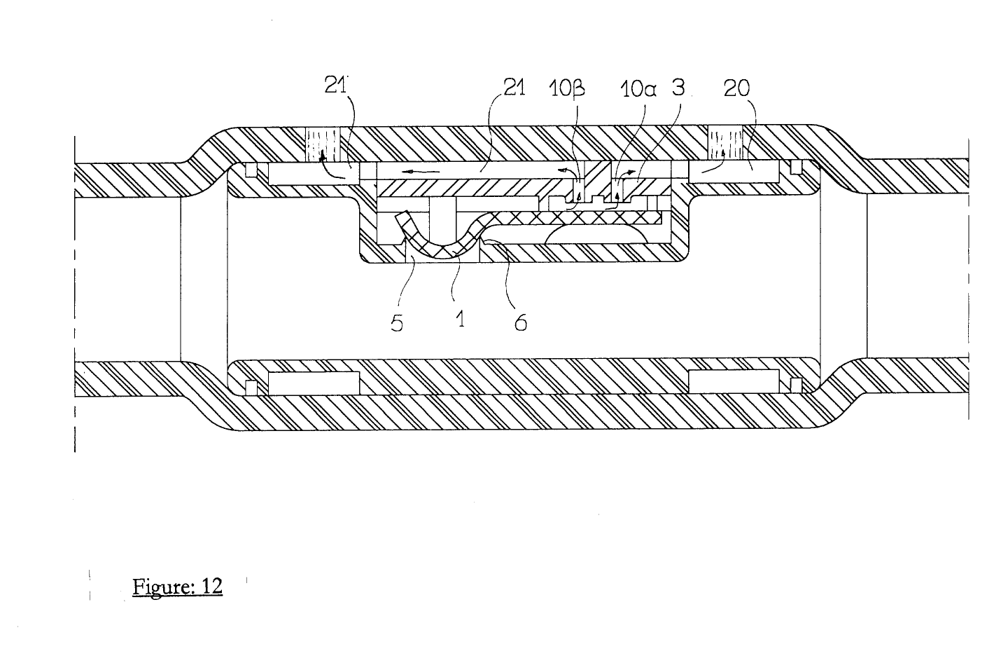

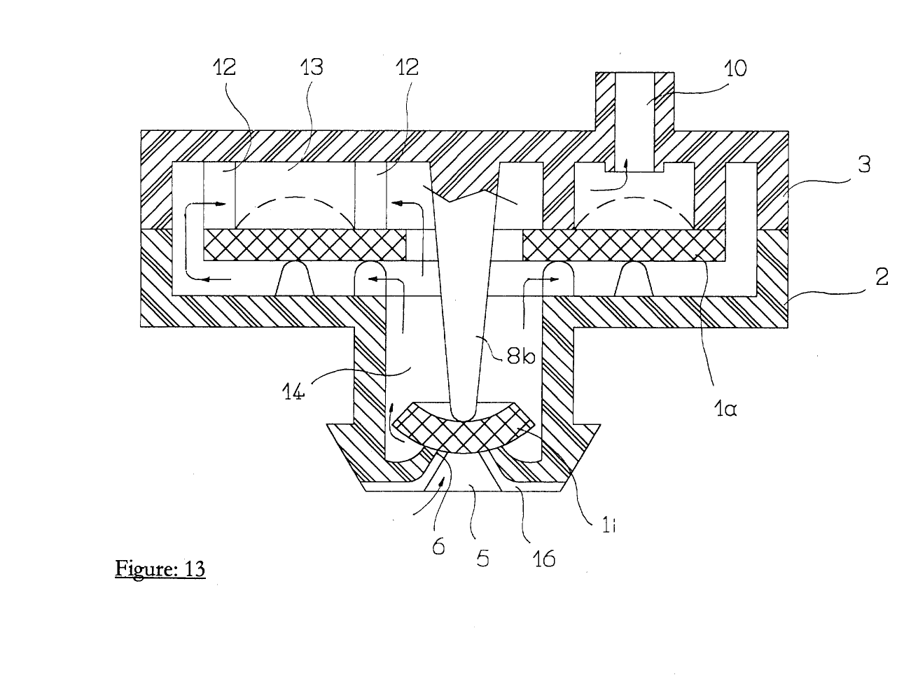

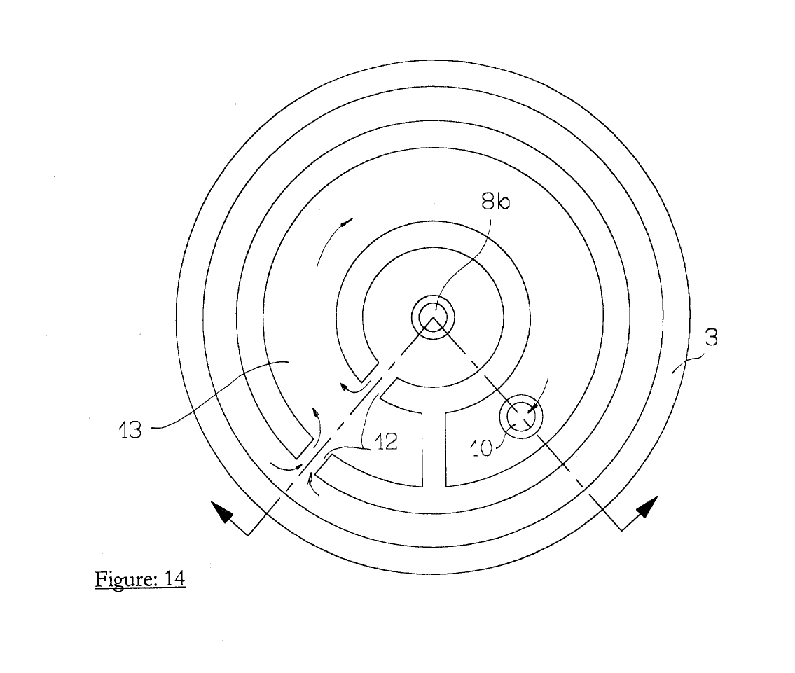

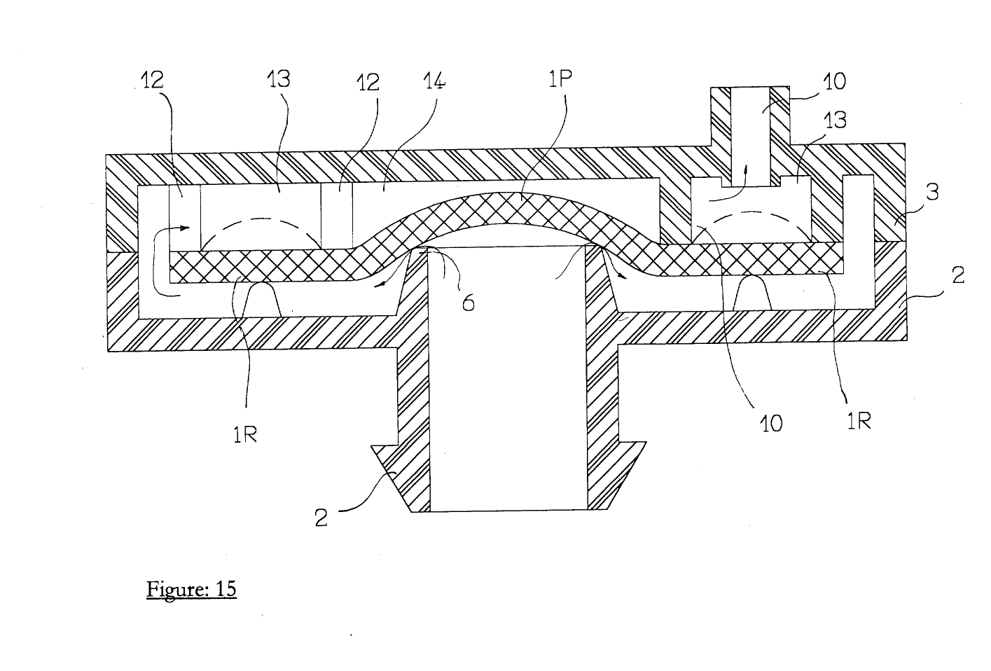

The present invention relates to self-compensating, constant discharge emitters used for irrigation purposes and in particular to a dynamic arrangement that filters the water under constant conditions, prior to its inlet to an emitter.

State-of-the-Art

All the existing known technologies for self-compensating emitters had to solve the following problems:

a) to filter the inlet water

b) to prevent blockages, ensuring the emitter has the widest, shortest and simplest water paths possible

c) to maintain a constant discharge for all the range of pressures in the network, i.e. For both high and low pressures

d) to operate as a non-return valve

e) to reduce the emitter volume

Patent PCT/GR 96/00004, despite the fact that the bending and relative movement of a membrane removes foreign matter, failed to solve the problems. Water passes through particular channels, engraved onto the surface of the common filtering and discharge adjustment chamber, that on one hand determine the quality of filtering, but on the other hand, should they get blocked, the membrane that moves onto them will not manage to penetrate their interior part and clean them. Furthermore, the position of the membrane is not determined but always depends on the pressure of the water in the network. The membrane does not tighten the emitter at any phase of its operation and water enters and exits freely even if no pressure exists in the network, resulting in:

The network is emptied from water immediately after the interruption of irrigation and a long time is required for re-filling before the operation restarts.

All emitters do not start operating simultaneously; instead the start-up of their operation is random and uncontrolled, whereas a long time is required until uniform operation of all emitters of the network is achieved.

The emitter is not tight in the case of depression in the network and so foreign matter penetrates into the emitter in the opposite direction, from the water outlet hole

Regarding other known patents, they have failed to solve to a sufficient extent any other problem, bar apart from the non-return valve; for example, water inlet holes covered by the membrane in patents for self-adjusting, constant discharge emitters, such as EOP 0482843 A1, EPO 730822 A2, SP 2137825, FR 2687540 A, Us 6027048 A, in no way can be considered as filter, as will become evident in the sequel, despite the fact that water inlet to the emitter is possible, only once a predetermined pressure is achieved and the inlet hole is revealed.

In more detail, in these technologies, the common membrane is located between two facing rims or holes, i.e. the inlet hole or rim—which it covers tightly—and the outlet or discharge adjustment rim or hole. If the distance between the two facng holes or rims and hence the width of variation of the membrane is H, and the distances from the inlet and outlet holes or rims are H1 and H2, respectively, the relationship H=H1+H2 (1) holds. From the moment that the membrane will be raised from the inlet rim that operates as a non-return valve, it must automatically move immediately towards the opposite rim for the final or partial adjustment of discharge and remain there. It makes no difference whether the opposite rim concerns a rim for final or partial adjustment of discharge (e.g. Patent SP 2137825, Patent PCT/GR 96/00004). After operation start-up, and throughout the irrigation, the common membrane of the system operates at the opposite outlet hole from which it is displaced by a smaller or larger distance, depending on the pressure P1 of the network. In general, its position, i.e. the value of H2 always depends on the pressure of the network, as a adjustment of the discharge is proportional, and this is a characteristic of all known technologies. Hence, due to the relationship (1), the higher the value of the distance form the outlet rim, H2 is, the shorter the distance HI of the common membrane from the water inlet rim is. The void space for water inlet H1 is not, hence, steady, despite the constant by definition discharge Q of the emitter. Anyway, as the range of operating pressures of the emitter must be very large, both the range of variation of the displacement of the membrane H, as well as the range of variation of H1 must also be very wide. Characteristic example of a very wide range of variation of H1 is given by patent FR. 2687540 A. Hence, a void space H1, with the wide by definition variations of its value cannot constitute a filter for the protection of the emitter from blockages. Apart from it, the same known technologies do not propose sufficient solutions for preventing blockages and for the reduction of the volume of the emitter, as they cannot operate and maintain water discharge steady at low pressures range in the water supply network, without the presence of a long meander-like path that is necessary and serves the purpose of additional pressure drop in regions of low pressure range. However, the presence of this additional meander-like path on one hand increases the blockage problems and on the other hand increases the volume, a very significant disadvantage of an emitter placed inside a small diameter tube. In detail: During the operation of the emitter at low pressure networks, i.e. at pressures equal or slightly higher that the pretension pressure of the membrane, the membrane is raised slightly, permits water inlet, but also must move directly and steeply towards the opposite rim for discharge adjustment. I.e., it must reduce sharply and not proportionately the distance H2 in order to “strangle” the excess pressure, irrespectively of how low it is, that tends to increase the emitter discharge to sizes double or triple the nominal discharge Q. This phenomenon is always observed at the end of the dripline tube, where lower pressures prevail in general, as well as temporarily at the beginning of the dripline tube, before the network pressure is re-instated and negatively affects the operation of the whole system.

During the initial water inlet, with the membrane opening, a pressure drop ΔP1 develops due to the passage of water through the initially narrow void space H1. However, the pressure drop, ΔP1, although enough for displacing the membrane to the opposite rim immediately and sharply, it may not act especially here, as while the membrane is displaced, reducing the value of H2, the value of H1 increases according to equation (1) and ΔP1 is reduced. The initial value of the pressure drop ΔP1 is created due to the initially narrow size of H1, and weakens as the latter is increased. Hence, an auxiliary pressure drop ΔP2 is required that will replace the reduction of ΔP1 and with the residual value of the continuously decreasing ΔP1 will displace the membrane, immediately and sharply.

The displacement of the membrane and the maintenance of constant discharge may not be effected for the existing technologies, without an auxiliary side meander-like path that connects the inlet hole or rim to the opposite outlet hole or rim. This path adds the additional and almost equal pressure drop ΔP2 for the sharp displacement of the membrane towards the outlet rim, with all the associated problems of volume increase and blockages that the presence of such a meander-like path implies.

Regarding the second variation of EP 730822 A2, the membrane cannot be raised. The water pressure from the side of the convex part of the membrane is higher and the pretension of the membrane cannot be overcome so that it is raised and permits water inlet. It concerns a design error.

Another great problem is presented in the method of assembly of the parts of the emitter. The tight emitters are particularly stressed by the reduced pressure usually formed in the network, and tend to reassemble during this phase of depression in the network.

The solution offered by patent WO99/18771 and U.S. Pat. No. 6,027,048 is very expensive as it requires on one hand an extremely complicated assembly between two parts and on the other hand simultaneous welding of the peripheral rims of both the main body and the cover of the emitter with the inner part of the tube. In this manner, due to the very large surface and the welding arc and contact finally formed, the part of the emitter that welds to the tube and its radius of curvature are strictly determined and a complete differentiation and attachment of the external body and the emitter radius of curvature are required, for each new tube diameter to which it will be welded. Hence, a different injection mould is required for each tube diameter.

### BRIEF DESCRIPTION OF THE INVENTION

The present invention relates to an arrangement for water inlet to the self compensating, steady discharge emitter. It consists of an opening with a circumferential ring and sharp rims that is completely covered by an elastic membrane. This region is the filtering chamber.

The membrane is continuously pressed at its centre and perhaps at its circumference so that a slight permanent pre-tension and bending occurs, with the convex surface of the membrane located towards the direction of water inlet. When water pressure in the tube exceeds some pre-determined value, i.e. the pressure exerted by the pre-tension to the membrane, the membrane is raised slightly above the ring and water enters into the emitter and evidently in the space behind the membrane where atmospheric pressure prevailed beforehand.

As the circumference of the inlet opening is larger than the circumference of the outlet opening, the necessary raising of the membrane for the particular nominal water discharge to pass and hence the dimension of foreign matter that may enter into the emitter is particularly small.

The size of raising and hence the void space H1 for water passage remains small and constant for all pressure values along the network and the membrane occupies at all phases of emitter operation and all values of network pressures, only two absolutely discrete positions:

Position 1:

Network pressure smaller than the predetermined value required for overcoming pretension of the membrane. The membrane covers the ring completely and tightly. No water enters into the emitter, degree of raising H1=0.

Position 2:

Network pressure equal or greater than the predetermined value. The membrane is raised and remains at a constant height H1 above the inlet rim, irrespectively of the value of pressure of water in the network.

A void space H1 is formed for water passage and ideal conditions are formed of absolutely constant and controlled filtering. The system operates as an ON-OFF valve with two absolutely discrete positions, whereas the void space H1 opens and closes at each start-up and interruption of operation, essentially self cleaning this arrangement for water filtering. The self-compensation and the maintenance of steady discharge of the emitter is effected in the adjustment chamber., a space which is completely different in terms of functionality and space than the filtering arrangement. The adjustment chamber is covered by another part of the membrane, or an altogether different membrane.

The emitter has a small volume and is particularly simple and withstands blockages as the presence of the meander-like path for its operation at low pressure regions is not necessary.

Two further innovations, general in nature, are related to the present invention:

One relates to the assembly of the parts of the emitter by welding not only the body of the emitter with the tube, but also a small part of the emitter cover.

Essentially, it concerns an add-on welding to the tube of two or three small vertical shafts of the cover that pass through the body of the emitter. The advantage, apart from the extreme easiness of assembly is that the surface of contact and welding between emitter and tube does not increase and that the part of the circumference (arc) of contact of the emitter with the tube remains small. Thus, the radius of curvature of the emitter in the region of welding is not strictly determined and the same emitter, from the same mould can be welded to tubes of all different diameters.

The other relates to an emitter with two similar holes for the final adjustment of discharge that communicate independently with two separate outlet chambers at the two ends of the emitter. If two holes are opened to the tube at the two ends of the emitter, both final adjustment holes are activated simultaneously. Their discharge is added and becomes double the nominal value. However, if only one outlet hole is opened, at any of the corresponding ends of the emitter it corresponds, only the respective final adjustment hole is activated. In this case, only the nominal flow comes off the emitter.

One of the several advantages is with the simultaneous arrangement of two instead of one hole, the ability to multiply selectively the water discharges without increasing the number of emitters per unit length of tube is available.

### DESCRIPTION OF THE DRAWINGS

Drawing 1. Cross section of an emitter with one water inlet opening

Drawing 2. View of the external part of the cover of the emitter of drawing 1.

Drawing 3. Plan view of the internal part of the cover of the emitter of drawing 1

Drawing 4. Plan view of the internal part of the main body of the emitter of drawing 1

Drawing 5. Cross section of the emitter of drawing 1 with the membrane raised

Drawing 6. Cross section of an emitter with the concave surface of the membrane in the direction of water inlet

Drawing 7. Cross section of an emitter with membrane flat at start, prior to execution of pre-tension or bending

Drawing 8. Plan view of the main body of the emitter of drawing 7.

Drawing 9. Plan view of the internal part of the body of the emitter with two similar outlet holes for outflow and final adjustment of the discharge.

Drawing 10. Plan view of the external part of the body of the emitter of Drawing 9.

Drawing 11. Transverse cross section of the cylindrical emitter of drawing 9, with two outlet openings.

Drawing 12. Longitudinal cross section of the emitter of drawing 9.

Drawing 13. Cross section of an ON-LINE emitter with two independent membranes

Drawing 14. Plan view of the main body of the emitter of drawing 13 with the circumferential chamber

Drawing 15. Cross section of an ON-LINE emitter with one membrane.

Drawing 16. Transverse cross section of the emitter of Drawing 1 with small shafts welded to the tube

### DETAILED DESCRIPTION OF THE INVENTION

Drawings 1, 2, 3, 4, 5 and 16 illustrate cross sections of an emitter welded in the internal part of a tube 4. The elastic membrane 1 exists between the main body 3 and the cover 2.

The cover 2 of the emitter bear the opening 5 for water inlet with the ring 6 and the circumferential edge with the sharp rims 7 that are continuously and fully covered by the part 1e of the membrane 1.

The body 3 of the emitter bear a pin 8 which exerts permanent pressure pretension onto the part 1e of the membrane 1, the convex part of which extends to the external surface of the cover 2 of the emitter. Since the emitters with membranes examined in this case are self-adjusted and feature an elastic membrane, the part 1e of the membrane 1 over the ring 6 operates as an inlet filter whereas another independent part 1c at the other end of the same membrane 1 above the outlet hole 10, adjusts and maintains the water discharge steady for all values of pressure P1 in the network.

The wide space 14 with the hole 5, the ring and the part 1e of the membrane 1, constitute the inlet or filtering chamber, whereas the space 13 with the outlet hole 10 and the part 1c of the membrane 1 constitute the discharge adjustment chamber.

It is evident that for the flow to be maintained steady, the part 1e of the membrane 1 located above the outlet hole 10 will assume each time different positions and hence a different distance from the rim 10 according to the pressure P1 exerted to the network each time.

Opposite to that, the part 1e of the membrane 1 that corresponds to the inlet hole 5, i.e., to the ring 6 and the edge 7 will be raised only when the pressure P1 of water in the network becomes equal or greater than the particular value Pa required for overcoming the pretension force Pr exerted to the membrane by the pin 8.

Since water enters the emitter due to the pressure drop caused exactly by this water inlet, a smaller pressure P2 develops in the space numbered 14, at the filtering chamber at the rear part of the membrane le, and hence a pressure difference ΔP=P1−P2 develops at the front and behind of the part 1e of the membrane.

As seen in the drawings, no outlet holes exist in space 14, that are covered by the membrane 1e during its movement and cause additional pressure drops, and thus ΔP1 alone acts in the region of the membrane 1e.

It is evident that in case of equilibrium, of the raised membrane 1e, the relationship (P1−P2)F=Pr must hold for the forces exerted to the membrane, where F is the surface of the inlet opening 5 or the membrane 1e. Since the magnitudes F and Pr are steady, and ΔP1 is a constant value, independent of the values of P1 and P2, where under the condition that the emitter has by definition a constant discharge value Q, ΔP1 only depends on the pretension Pr. It is evident that the inlet velocity of water V1=√(2gΔP1) is constant, and the measure of the raising H1 is constant and uniform above the ring 6 and the edge 7. The last derives from the discharge relationship Q=F1. V1 (3) where F1 is the inlet surface of water which in our case is expressed as F1=U.H1 where U is the circumference of the ring 6 of the opening 5. Hence, with U being constant, H1 is also constant. In the phase of raising, water inlet to the emitter and starts for the first time and simultaneously, the operation of the absolutely controlled filtering of inlet water also starts.

As the circumference of the ring 6 is very large relative to the circumference of the opening 10 for water outflow from the emitter, a minimum raising H1 of the part le of the membrane is required (drawing 5) for the passage of the particular steady nominal water flow Q.

Foreign matter, with dimensions larger than the constant measure of raising H1, cannot descend to the emitter and with the end of operation of the emitter and the drop of pressure at values below Pa, the membrane 1e touches and covers the edge 7, and the foreign matter that may exist in the region of the ring 6 and the rim 7, are detached from the emitter.

A dynamic, self-cleaning filter is formed with moving elements. The part 1e of the membrane 1 above the inlet opening 5 is aimed to take, according to the previous descriptions, at all phases of emitter operation and all values of pressure P1 in the network, only two discrete positions:

Position 1:

Water network with pressure smaller than the predetermined value Pa required for overcoming pretension. The membrane covers the ring completely and tightly. No water enters into the emitter, degree of raising H1=0.

Position 2:

Water Network with pressure equal or greater than the predetermined value Pa. The membrane is raised ant remains at a constant height above the inlet rim, irrespectively of the value of pressure of water in the network. I.e., a stable, very narrow void space H1 is formed for water passage and as a result, ideal conditions for steady filtering develop.

Hence, the system operates as an On-OFF valve with two absolutely discrete positions. It is evident that the quality of filtering achieved due to the very small void space H1 that opens and closes, being essentially self cleaning at each operation start up and interruption of function of the emitter, cannot be compared with any one of the known emitters.

Apart from all that, foreign matter that could not penetrate due to their larger size cannot remain coagulated at the inlet 5 of the emitter for another reason: They are carried over by the continuous passage of the water through the parallel external channels 16 of the cover 2 which have the same direction as water in the tube 4.

Water, having overflown over the edge 7 towards the wide space 14, follows the the path 11 of the space 11 behind the membrane 1c and through the passage 12 enters to the space 13 of the chamber for the final adjustment of the discharge, behind the membrane 1c that also bears the outlet hole 10. The distances H2, of the part 1c of the membrane from the rim 10, in order that the discharge is maintained steady, are proportional to the pressures prevailing at any moment at the spaces 11, 12 as well as in the network. However, the displacements of the two ends 1e and 1c, of the, common membrane 1 at the inlet regions 5 and final adjustment regions 10, are totally independent of each other.

In another variation, the convex part of the membrane extends further down from the external surface of the cover 2 of the emitter (not drawn).

In another variation, after the path 11 and before the entrance into space 13, a part of a static meander-like path could exist, covered by part of the membrane, or not, for achieving additional water pressure drop. This meander-like path could be traced both in the body 3 as well as the cover 2 of the emitter (not drawn).

In another variation, instead of one inlet hole, more holes with edges and pins for exerting a permanent pressure exist, covered by the same or different membranes (not drawn).

In another variation, two independent membranes exist, of which the first operates as a filter only in the filtration chamber, whereas the second operates only as a system for the adjustment of water discharge in the adjustment chamber (not drawn) In another variation, the convex part does not extend to the lower surface of the cover 2 of the emitter (not drawn)

Alternatively, both the edges 7, as well as the rings 6 can bear at parts of their circumference, small channels so that after the start-up of the operation of the emitter, once the predetermined pressure to the network that will permit raising of the membrane 1, is achieved, the water passes through only one particular part of the circumference of the ring (not drawn).

In another variation, the inlet hole may have a shape other than circular, e.g. rectangular, ellipsoid, or the pin 8 may not exert the pressure at the center, but off-center, or more than one pins may exist (not drawn).

A similar behaviour is observed in the cases of drawings 7 and 8. The membrane 1k is flat and covers fully and tightly the inlet hole 5c even when no pressure exists in the network and the emitter does not operate. Opposite to the case of patent PCT/GR96/0004, in this case the emitter is absolutely tight.

In this case also, the wide space 14c with the rings 6c, 6a and the passage 19 and the part of the membrane 1K constitute the inlet chamber or the filtering chamber, whereas the space 13 with the outlet hole or rim 10 and the part 1L of the membrane, constitute the chamber for adjustment of the discharge.

Water inlet to the emitter occurs only after the pressure to the network reaches a particular predetermined value, in which case due to the pressure exerted, the membrane 1K is bent further and penetrates and is all displaced with its convex part towards the internal part of the inlet hole 5c. Then, at some stage of the displacement, it reveals a passage 19 that starts at the rim 6a, significantly lower than the rim of the ring 6c. Thus the void space Δ1 is formed that corresponds to the raising H1 of drawing 5. The membrane 1K also takes a particular position in order to maintain the particular size Δ1 of the void space steady, whereas the water passes in the sequel through the inlet 12 from space 14c to the space 13 of the chamber for the final adjustment, that bears the outlet hole or rim 10. The exertion of the pressure P1 of the network to the part 1L of the membrane that corresponds to the space 13 is effected through the holes 20 of the cover 2 and the pin 8P exerts the pretension onto the membrane 1K. The broken lines show the positions of the membrane during operation.

As seen from the description and the drawings 7 and 8, the inlet 12 does not constitute a path for an additional drop of the water pressure, but only the connection of the filtering and discharge adjustment chambers. In the wide space 14c, the pressure P2 develops as known, and hence, the same pressure P2 also prevails in space 13 behind the part 1L of the membrane. Hence, the known steady pressure drop ΔP1 will move the membrane sharply and directly towards the opposite rim 10, ensuring the unhindered adjustment of the discharge, as soon as the operation of the emitter starts, i.e. as soon as the part 1K of the membrane is raised and reveals the constant void space Δ1. This operation will be repeated unchanged in the same manner, whether it concerns a low pressure or a high pressure region. Here, Δ1, as well as H1 in drawing 5, only depends on the pretension of the membrane and has been calculated so as to be sufficient for immediate and drastic displacement of the membrane 1L without requiring additional pressure drop from any additional meander-like path that only brings additional problems.

Drawing 6 illustrates another variation with the concave surface of the membrane 1X towards the direction of the water inlet. Pretension is caused both by the pin 8a, as well as circumferential ring 9. The broken lines illustrate the positions of the membrane during operation.

In this case as well, the membrane 1X is raised by H1 after it has achieved a particular pressure in the network, the value of this pressure depending again by the pretension and only. Otherwise, the same apply as for the cases of drawings 1 to 5.

In another variation of drawing 6, the pin 8a could be absent. However, the circumferential pretension ring 9 is maintained (not drawn).

In another variation a problem is examined that relates to tubes used in tree cultures where alternate variable flow water discharge is required, e.g. higher discharge near trees with root systems and lower discharge in the spaces in between. The solution in these cases as all the emitters have the same discharge, is to increase or decrease alternately the distances of the emitters onto the tube, by the application of distance programming in the automatic tube production and emitter installation line.

This solution is expensive because apart from the special programming, requires a number of emitters in a particular tube length, far higher than the usual one.

Drawings 9 to 12 illustrate a solution to this problem that concerns all the types of emitters but is illustrated for the case of a cylindrical emitter. The overall arrangement of filters and water discharge adjustments is identical to that of drawings 1 to 5, i.e. the principal water path is the same and common, but the rim or hole 10 for the final adjustment is double (10a and 10b). Respectively, independent channels for water outlet exist (20 and 21) which start from the respective holes 10a and 10b and are directed towards the two independent chambers for final outlet (23 and 22) of the emitter. The rims 10a and 10b are identical, featuring the same height, etc. and symmetrical and the membrane 1 covers them in exactly the same manner at all operation stages.

When the outlet hole 24 of the tube is opened above the region of space 22, then only the adjustment hole 10b is activated, whereas in the opposite case, only 10a is activated. In both cases, the nominal water discharge flows through the hole 24. This arrangement also serves another operation, this time being a practical one, which is the orientation of the emitter during the phase of integration into the tube. With this arrangement of similar holes, no emitter orientation is required, that may enter the tube in any direction. Irrespective of the emitter edge where the perforation will be effected the discharge will be the same, i.e., the nominal one.

However, if the tube is pierced at two positions and outlet holes are formed above the two spaces 22 and 23, then water flows simultaneously out of both adjustment holes 10a and 10b. Water is driven simultaneously but independently towards the two spaces 23 and 22 and the capacity of the particular emitter is doubled. Different applications of this variation include:

The first piercing is made from the automatic production line and the second at the field where the system is installed by the personnel and at the required locations near the trees.

The automatic production and emitter incorporation line operates based on special programming for alternate single or double piercing.

If only one hole is to be opened in general, then the second may be opened by the personnel operating the system in-situ, in case of blockage of the first. Thus a second stand-by outlet hole may exist.

In all three cases all the emitters have the same distances between them. The number of emitters onto the tube, thus does not change.

Drawings 13, 14 illustrate another variation of an ON-LINE emitter with two independent circular membranes 1i and 1a located at different levels as well. The membrane 1i operates as an inlet filter, whereas membrane 1a aims at maintaining the water discharge steady. Full correspondence with the cases of drawings 1 to 5 exists. In this case, the space 13 for the adjustment of the discharge extends along the circumference for achieving a smaller emitter height and the membrane 1a bears a hole for the pin 8b for the pretension to pass. In another variation, some support could pass through the hole for supporting the other membrane in general.

In this case the small channels 16 are arranged radially. The arrows show the direction of the water in the emitter. Drawing 14 illustrates a plan view of the main body 3. The adjustment chamber 13 may also bear a meander-like path.

Drawing 15 illustrates another variation of an ON-LINE emitter with only one circular membrane 1. The part of the membrane 1P around its centre operates as a filter, whereas the part of its circumference 1R adjusts the discharge. The broken lines illustrate the position of the membrane during its operation. It is self evident that other parts of the same membrane 1P and 1R move independently of each other. It is evident that he invention is also applicable for cases where the discharge adjustment system is different than that described in this descriptions and drawings. Furthermore, all emitters described here can be also used by tubes formed by folding and raising the edges of a longitudinal plastic tape for forming a tube (TAPE)

In another variation the pin could have at the point of contact with the membrane the form of the curve of the bent membrane at the final phase of raising it by a distance of H1 (drawing 5).

Drawings 1 to drawing 4 and drawing 16 illustrate a method of assembly of the parts 2 and 3 of the emitter. The tight emitters-in general are subject to stress by the depression that usually prevails in the network and tend to disassemble during the low pressure phase. The known methods of assembly of parts 2 and 3 are reinforced in this case by three small shafts 25, 26 and 27 of the cover 2 which penetrate with tightening action into respective holes 25a, 26a, 27a of the main body 3. The small shaft 26, though, also passes through a hole 30 of the membrane 1 without tightening activity with the membrane. The ends of the small shafts protrude both above the external surface of the emitter and are welded together with body 3 into the tube 4. In another variation, only one, the middle-26, or the terminal-26 and 27-small shafts may exist (not drawn).

This method of additional attachment with small welded shafts is more advantageous than a complete and simultaneous welding of both all the circumferential rim 30 of the cover 2, as well as the rims 28 of the main body 3 with the tube 4, as proposed by patent WO99/18771. The advantage lies in that the length of the arc 29 of the circumference of the emitter where the welding is performed remains small, resulting in the external radius of curvature of the emitter to fit all tube diameters to which it will be welded and in avoiding the need of a different emitter mould with a different radius of curvature for each different tube diameter. A simple disadvantage is that the method of assembly of the two basic parts of the emitter is very complex.

1. Self-compensating constant discharge emitter with a water inlet chamber consisting of an inlet ring (6c), a part of a membrane (1K) which is permanently pressed onto the ring (6c) so that a light pretension develops that tightens the wide space (14c) located under the membrane (1K) and a discharge adjustment chamber consisting of the inlet hole or rim (10) with which it co-operates, and the space (13) under the membrane (1L). The part of the membrane (1L) proportionately alters its distance (H2) form the outlet hole (10) depending on the pressure prevailing in the network, in order to maintain the discharge of the emitter steady. Water enters into the emitter from the inlet chamber, should the pressure in the network exceeds a predetermined value, suppresses the part of the membrane onto the ring and forms a void space (Δ1) for the water to pass. The emitter is characterised by that: The inlet chamber with the external ring (6c) and the pre-tensioned membrane (1K) that covers it, bears a second internal ring (6a) at a lower level, which bears the opening (19). These parts, together with the wide space (14c) behind the membrane (1K), constitute a functionally integral space, the filtering chamber, having as sole aim the filtering of the water inflow by maintaining the void space (Δ1) steady. The filtering chamber is spatially and functionally independent of any chamber for the partial or final discharge adjustment. The wide space (14c) behind the part of the membrane is free of rims or passage holes or other paths for water pressure drop that could be blocked by the membrane (1K) after its immersion. The filtering chamber functions as an ON-OFF valve with two totally discrete positions. First position: Emitter closed, zero void space height (Δ1). Second position: Emitter in operation, particular and fixed void space height (Δ1), independent of the pressure of water in the network.

2. Self-compensating constant discharge emitter with a water inlet chamber consisting of an inlet ring (6), a part of a membrane (1e) which is permanently pressed onto the ring (6) so that a light pretension develops which tightens the wide space (14) located under the membrane (1e) and a discharge adjustment chamber consisting of the inlet hole or rim (10), a membrane part (1c) in front of the hole with which it co-operates, and the spaces (11), (13) in front of and behind the membrane (1c), respectively. The part of the membrane (1c) modifies proportionately the distance (H2) from the outlet hole (10) depending on the pressure prevailing in the network, in order to maintain the discharge of the emitter constant. Water enters into the emitter from the inlet chamber, should the pressure in the network exceeds a predetermined value, which overcomes the pretension, lifts the part of the membrane (1e) over the ring (6) and forms a void space (H1) between the ring (6) and the membrane (1e). The emitter is characterised by that: The inlet chamber with the inlet ring (6) the pretension part of the membrane (1e) that covers it, and the wide space behind the membrane constitute a functionally integral space, the filtering chamber, having as sole aim the filtering of the water inflow through the fixed void space (H1). The filtering chamber is spatially and functionally independent of any chamber for the partial or final discharge adjustment. The wide space (14) behind the part of the membrane (1e) is free of rims or passage holes or other paths for water pressure drop that could be blocked by the membrane (1e) after its initial lift. The filtering chamber functions as an ON-OFF valve with two totally discrete positions. First position: Emitter closed, zero void space height (H1). Second position: Emitter in operation, particular and fixed void space height (H1), independent of the pressure of water in the network.

3. Emitter according to claims 1 and 2 where the water inlet is effected through the whole surface of the ring.

4. Emitter according to claims 1 and 2 where the water inlet is effected through part of the surface of the ring.

5. Emitter according to claim 2 where the water inlet is effected through more than one water inlet hole.

6. Emitter according to claims 1 and 2 where the membrane of the hole of the filtering chamber is independent of the membrane of the final adjustment chamber.

7. Emitter according to claim 1 and 2 where a meander-like part interferes between the filtering chamber and the chamber for discharge adjustment.

8. Emitter according to claim 2 where the membrane is permanently pressed by a pin (8) and the convex part of the membrane extends until the external surface of the cover of the emitter.

9. Emitter according to claim 8 where the convex part extends further than the external surface of the emitter.

10. Emitter according to claim 8 where the pin (8) has the form of the curve of the bend membrane at the final stage of its rising

11. Emitter according to claim 8 where the pin exerts an off-centre pressure to the membrane.

12. Emitter according to claim 8 where the convex part of the membrane does not extend until the external surface of the emitter cover.

13. Emitter according to claims 8 and 12 where the membrane, apart from the pin, is pressed by a circumferential ring (9).

14. Emitter according to claims 1 and 2, where the cover of the emitter bears at the region of the inlet hole external channels (16) parallel to the direction of the flow of the water.

15. Emitter according to claims 1 and 2, where the inlet ring has a noncircular shape.

16. Emitter according to claims 1 and 2, where the inlet ring bears small channels at parts of its circumference.

17. Emitter according to claims 1 and 2 where the membrane is permanently pressed by a circumferential ring and the concave part of the membrane is located in the direction of water inlet.

18. Emitter according to claim 17, where the membrane is also pressed by a pin.

19. Emitter according to claims 1 and 2, where its external shape is cylindrical

20. Emitter according to claims 1 and 2, suitable for ON-LINE installation

21. Emitter according to claim 20, with two independent membranes

22. Self compensating emitter where the final adjustment chamber (13) of the discharge bears two symmetrical and similar rims for the adjustmento e discharge (10a, 10b) which communicate via two independent paths (20, 21) with two independent outlet chambers (23, 22) at the twends of the emitter.

23. Emitter according to claim 22, where the piercing the outlet holes to the tube (24) is effected above the region of only outlet chamber.

24. Emitter according to claim 22, wh piercing oft he outlet holes to the tube (24) is effected above both outlet chambers

25. Emitter with two membraneat different levels (1, 1a) one of which (1a) is pierced for the pass of a longitudinal support (8) that will be used for the attachment the other (1).

26. Em itternaccopdg to claim 25 where from the hole of one membrane a pin passes Wthe exertion of pretension onto the other.

27. hod for the assembly of an emitter suitable for internal welding to a tube consisting of the main body, the cover and a membrane, characterised by that the parts are connected together with small shafts (25, 26, 27) of the cover (2) that enter with tightening press into respective holes of the main body (3), protrude until the external surface of the emitter and are welded together with the bod o the tube.

28. Method of assembly of emitter according to claim 27 where more than one membrane

29. Emitter according to claim 1-28 consisting of only one elastic part.
